(19) United States
(12) Patent Application Publication
(10) Pub. No.: US 2002/0188516 A1
(43) Pub. Date: Dec. 12, 2002

(54) Embedded product offering with real-time pricing and availability

(75) Inventors: Kimberly Patrick Farrow, Euless, TX (US); Michael Gerra, Irving, TX (US); Joseph Robert Offutt, Grapevine, TX (US); Sambamurthy Nalla, Irving, TX (US)

Correspondence Address: FINNEGAN, HENDERSON, FARABOW, GARRETT &, DUNNER LLP, 1300 I STREET, NW, WASHINGTON, DC, 20006, US

(73) Assignee: SABRE INC.

(21) Appl. No.: 09/875,053

(22) Filed: Jun. 7, 2001

(51) Int. Cl. G06F 17/60

(52) U.S. Cl. 705/26; 705/14

(57) ABSTRACT

Real-time pricing allows users to purchase products that are available at advertised prices via an advertisement on electronic commerce. If the price or availability of a product changes, the advertisement is updated to reflect this change. This allows the user to quickly and efficiently make purchases, without risk that the product will no long be available as advertised when he or she tries to make the purchase.

### FIELD OF THE INVENTION

The present invention relates generally to electronic commerce. Specifically, this invention relates to methods of embedding a product offering on a web site or other interactive network.

### BACKGROUND OF THE INVENTION

The Internet has allowed new businesses to develop and market themselves in previously unknown ways. New businesses are now operated out of homes with a personal computer as the only tangible asset. These new businesses must advertise to develop customer relations. The point-of-sale for a company may be its web site. In this case, the company must clearly entice customers to its web site if it is to make any sales.

To entice customers, a business may try using traditional means, such as newspaper, radio, and television, but all of these can be costly. Many such businesses will not have the available funds to perform this kind of marketing. Alternatively, a business may try electronic means of advertising, such as e-mail or placing a banner ad on another business's web site that provides a link to the advertising business's web site. These options also have drawbacks. E-mail is easily deleted and banner ads easily lose a potential customer's attention.

Currently, a business that markets its products on another's web site does so by creating a banner ad containing product information. If a user viewing the banner ad on a client computer selects the banner ad, the client's browser will either be sent to another web address or another window will appear. In either situation, the user will be presented with additional information concerning the lead product. The additional information displayed on the client may, in fact, inform the user that the product is no longer available. This can be problematic for a seller. The user may become frustrated and not pursue the purchase, or worse for merchants, the user may ignore all banner ads as containing unreliable, out-dated product information.

A solution is required that provides a user with real-time product information, such that the user may purchase a product as advertised.

### SUMMARY OF THE INVENTION

In one implementation, a client computer operated by a user may visit a site associated with a seller (i.e., the associate's site) while browsing sites on a network. The client requests the contents of a page associated with the associate's site. The contents are retrieved from a server, which may be stored in memory or elsewhere in the computer. The server will recognize that additional information is required from a supplemental server (i.e., a server that stores the seller's information). The information from the server and the supplemental server will be transmitted to the client and displayed via the client's browser. The information from the server includes variable data, which reflects real-time product information such as price and availability that may be updated as values for the data change, and may include executable code that requests undated information to the variable data.

In another implementation, a user visits an associate's web site while browsing the Internet. The user requests the contents of the web page associated with the associate's web site. The contents are retrieved from the server, which may be stored in memory or elsewhere in the computer. The server will detect that additional information is required to fulfill the request and direct the server to request additional information from a supplemental server. The information from the server and the supplemental server will be transmitted the client and displayed via the client's browser. The information from the server will include variable data and may include executable code. Between the client and supplemental server there is an open connection. As the supplemental server detects updated information, the server transmits the updated information to the variable data.

It is to be understood that both the foregoing general description and the following detailed description are exemplary and explanatory and are intended to provide further explanation of the invention as claimed.

Additional features and advantages of the invention will be set forth in the description that follows, and in part will be apparent from the description, or may be learned by practice of the invention The objectives and other advantages of the invention will be realized and attained by methods, systems, and apparatus particularly pointed out in the written description and claims hereof, as well as the accompanying drawings.

### BRIEF DESCRIPTION OF THE DRAWINGS

The accompanying drawings, which are incorporated in and constitute a part of this specification, illustrate implementations of the invention and, together with the description, explain the advantages and principles of the intention. In the drawings,

FIG. 1 is a pictorial diagram of a computer network in which systems consistent with the present invention may be implemented;

FIG. 2 shows a computer network containing a client system and server systems consistent with the present invention;

FIG. 3 is a flowchart of a process in accordance with the present invention;

FIG. 4 is a detailed flowchart of step 305 from FIG. 3;

FIG. 5 is a pictorial representation of the output of step 435 from FIG. 4;

FIG. 6 is a detailed flowchart of step 310 from FIG. 3; and

FIG. 7 is a detailed flowchart of step 330 from FIG. 3.

### DETAILED DESCRIPTION

Reference will now be made in detail to an implementation of the present invention as illustrated in the accompanying drawings. Wherever possible, the same reference numbers will be used throughout the drawings and the following description to refer to the same or like parts.

Systems and methods consistent with the present invention embed product offerings and provide real-time product information to clients via an associate's web site.

Embedded product offerings with real-time product information enable a business to sell goods via the Internet or other interactive network without requiring a user to visit the business's web site and without risk that the user will become frustrated that the offering has changed (for example, the price or availability is different from that originally displayed). The offering is presented to a user on an associate's web site, and the displayed product information is continuously updated to reflect real-time product information.

A product offering is made for a specified and available product at a specified and available price. As soon as the specified product and/or specified price is no longer available, the offering is updated to reflect a new price and/or new product that is available.

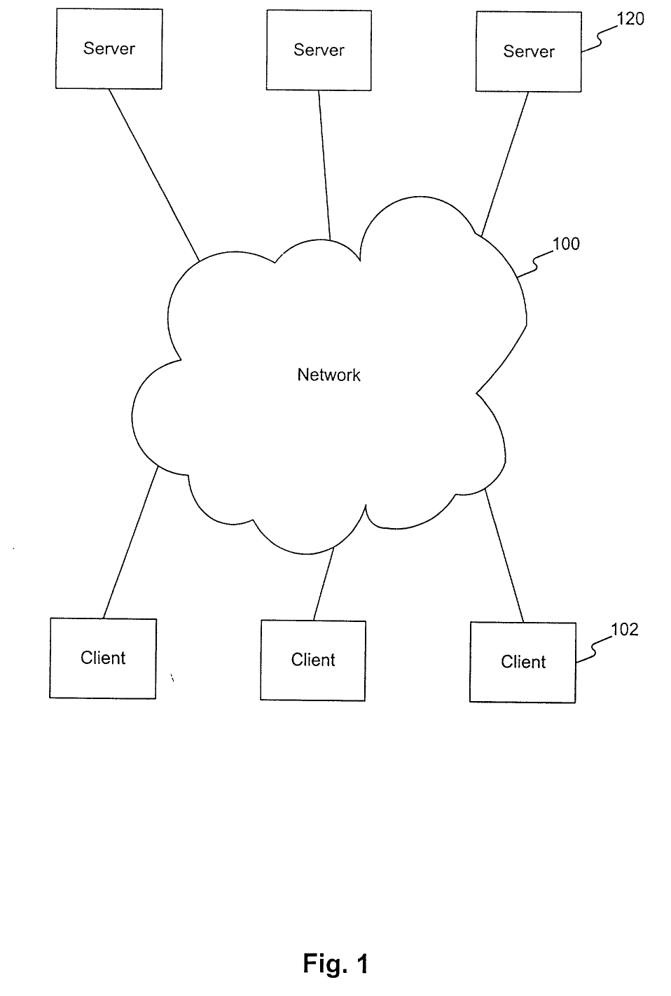

FIG. 1 illustrates a conceptual diagram of a network 100 in which systems consistent with the present invention may be implemented. Network 100 may simply be a connection between two or more devices with the ability to transfer data between them. More commonly, a network refers to an interconnection of networks, for example the Internet. Although the invention is described with respect to an interconnection of networks, it is equally applicable to a connection of two or more computers. Each device may be connected to network 100 in a variety of ways, including but not limited to an Ethernet connection, a wireless technology, and a cable modem.

The computer network 100 comprises client computers 102 and server computers 120. Commonly, client computers 102 (“clients”) are where human users operate a computer to request data from other clients 102 or servers 120 on a network 100. The terms “client” and “server” refer to a computer's general role as a requester or receiver of data (client) or provider of data (server). Each computer may request data in one transaction and provide data in another transaction, thus changing the computer's role from client to server or server to client. Moreover, the client or server might not be a computer but some other device capable of transmitting or receiving data, including but not limited to a cellular telephone, an electronic pager, and a personal digital assistant.

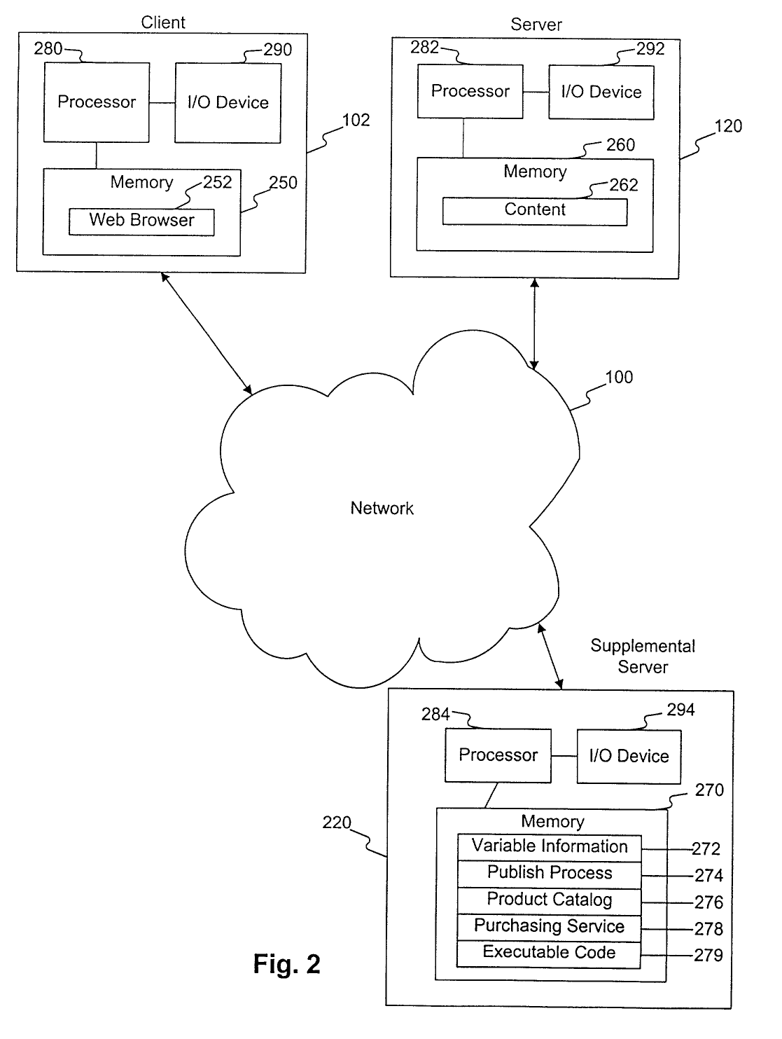

FIG. 2 illustrates a more detailed diagram of network 100 with specific connected devices. Client system 102 is comprised of a processor 280, an I/O device 290, and a memory 250 that stores a web browser 252. The processor 280 may be, for example, a Pentium microprocessor or a SPARC processor, may be used to process data, and is capable of requesting content, receiving content and data, and receiving updates to variable data. The I/O device 290 may facilitate connecting, for example, a mouse, a monitor, and a keyboard to a client system or connecting client system 102 to a network 100. The web browser 252 stored in memory 250 may be, for example, Microsoft Internet Explorer or Netscape Communicator.

Server system 120 is comprised of a processor 282, an I/O device 292, and a memory 260, which stores browser content 264. The processor 282 may be, for example, a Pentium microprocessor or a SPARC processor, may be used to process data, and is capable of receiving a request from a client device, providing content to a client device, and requesting data from a supplemental server. The I/O device 292 may facilitate connecting, for example, a mouse, a monitor, and a keyboard to a server system, or for connecting server system 120 to a network 100. The content 264 stored in memory 260 is information displayed as a web page on a web browser 252 and may be written in, for example, HTML or XML.

Supplemental server system 220 is comprised of a processor 284, an I/O device 294, and a memory 270, which stores variable data 272, a publish process 274, a product catalog 276, and a purchasing service 278. The processor 284 may be, for example, a Pentium microprocessor or a SPARC Processor, may be used to process data, and is capable of transmitting data and code to another computer. The I/O device 294 may facilitate connecting, for example, a mouse, a monitor, and a keyboard to a server system, or for connecting supplemental server system 220 to a network 100. The variable data 272 stored in memory 270 reflects real-time product information such as price and availability that may be updated as values for the data change, and may include executable code 279 that requests updated information to the variable data 272. The publish process 274 stored in memory 270 is a publish-and-subscribe technology, such as Prism made by PrismTech, located in the United Kingdom, TIBCO made by TIBCO Software Inc., located in Palo Alto, Calif., or MQSeries made by I.B.M., located in Armonk, N.Y. This component provides real-time updates to the variable data 272. The product catalog 276 stored in memory 270 comprises one or more products that the supplemental server 220 is interested in displaying, including relevant information associated with a product. For example, the supplemental server 220 may wish to display an airline ticket that is available for sale. Relevant information may include price and availability. A change in a value that is relevant to a product (e.g., price or availability change) will cause a change in the product catalog. This change will be published by the publish process to all interested devices or in response to a request for such information. For example, if an airline ticket between Minneapolis, Minn. and Austin, Tex. is sold for $200, the product catalog will change because of the sale, the change will be detected by the publish process, which will determine whether or not other products are available meeting the same criteria. If there are other products meeting the same criteria, then the variable data 272 will require no update. If there are no other products meeting the same criteria, then the variable data 272 will require updated information. One skilled in the art will recognize the update could occur either by transmitting the current value offered from the product catalog including when no change has occurred such that the displayed information does not change, or only transmitting a value when it has changed.

The criteria for information displayed in the variable data may be determined by an operator of the supplemental server creating a program that filers the information transmitted to an associated web site. Establishing such criteria will be referred to as “narrowcasting” for purposes of this specification.

For example, if an associate of the seller is a Greek travel agency, the operator of the supplemental server may wish establish criteria that displays the lowest available priced airline tickets to Athens, Greece. This allows the Greek travel agency (i.e., the associate) to potentially increase its market, because users operating clients have the opportunity to make travel arrangements to and from Greece from the same site where the user makes travel and tourism arrangements within Greece. Another example of narrowcasting is placing an advertisement on the AARP web site. Retired persons often travel, but it can be difficult to market flights specifically to retired persons. Advertising a flight on the AARP web site that is geared toward retired persons is an example of narrowcasting. The target audience is pre-selected, and the product is tailored to that target audience.

The purchasing service 278 stored in memory 270 provides an interface for a user operating a client to interact with a supplier of products. The supplier may be a direct supplier or a third party—for example, in the case of airline tickets, the supplier may be the airline directly or may be an intermediary. The executable code 279 stored in memory 270 may have various functions including but not limited to requesting periodic updates for the variable data 272 or invoking the purchasing service 278.

The client system 102, server system 120, and supplemental server system 220 are interconnected via a network 100.

One skilled in the art will recognize that components stored in memories 250, 260, and 270 may also be stored elsewhere in the device or on other devices connected to network 100.

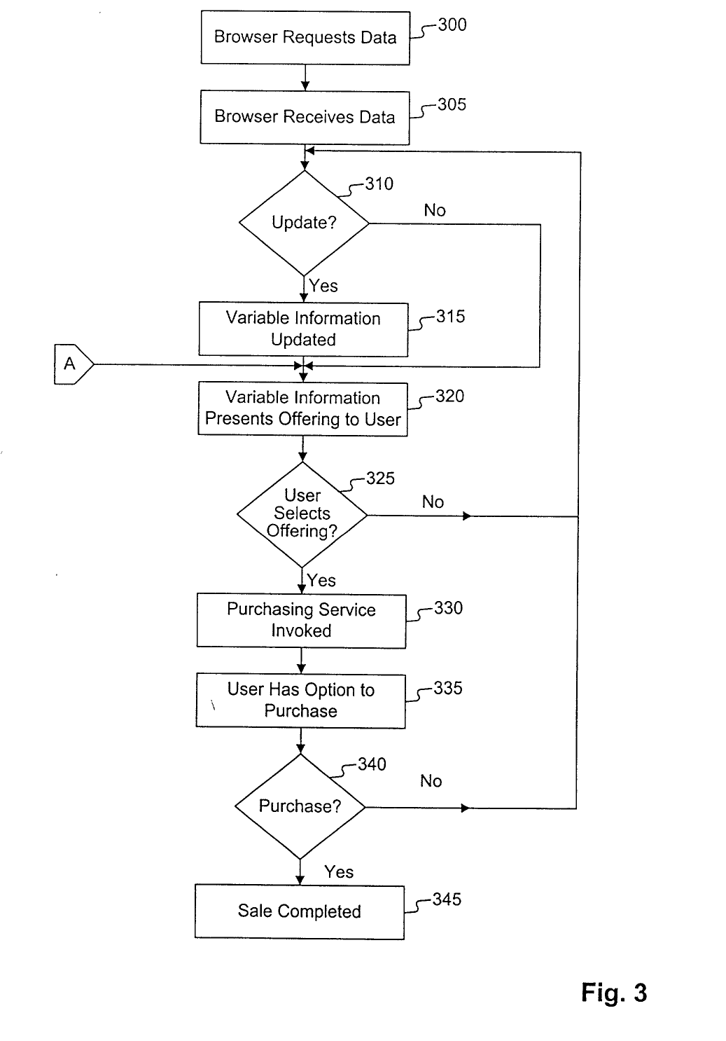

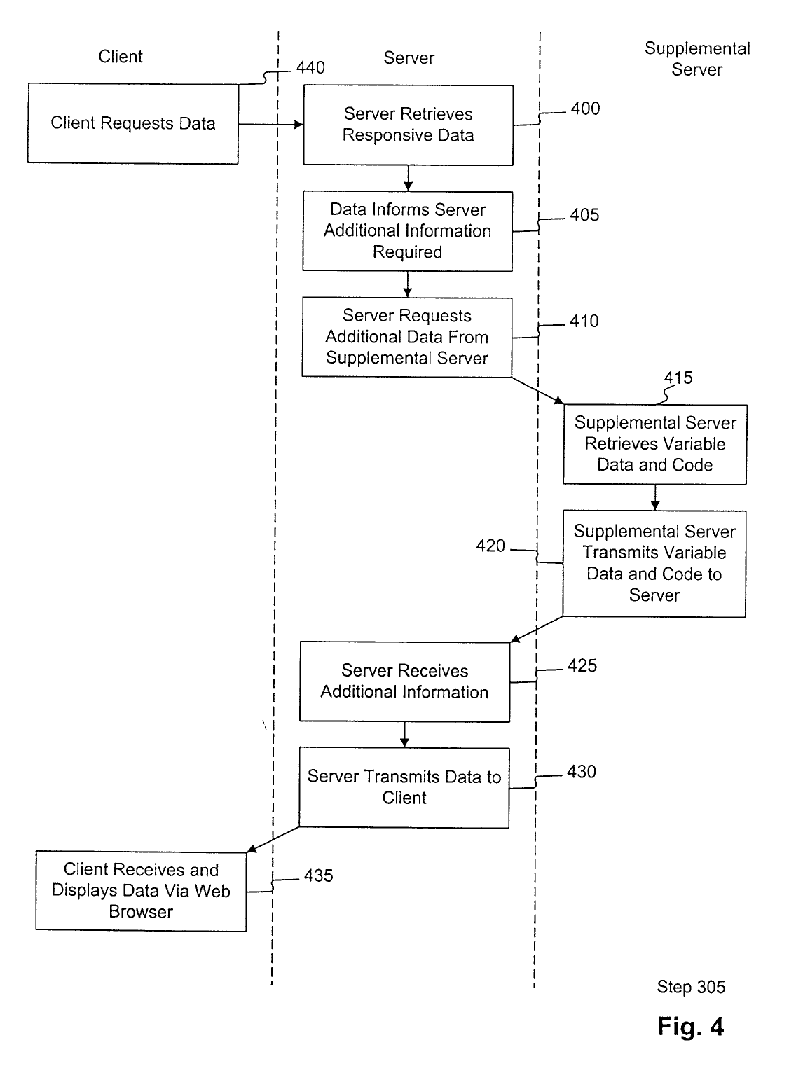

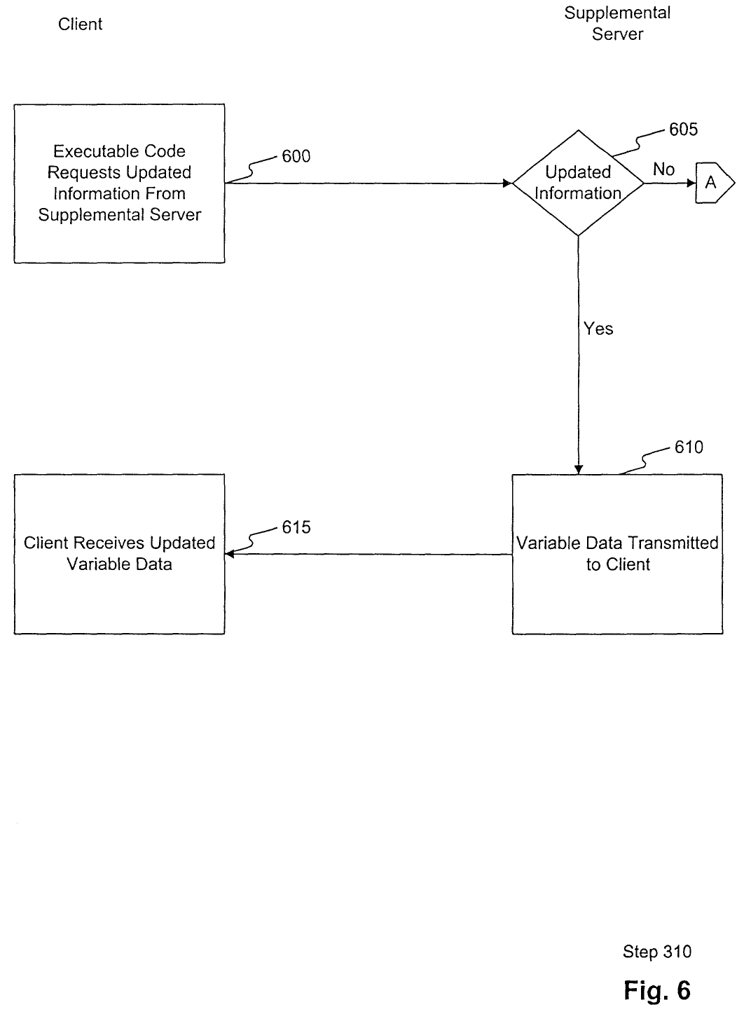

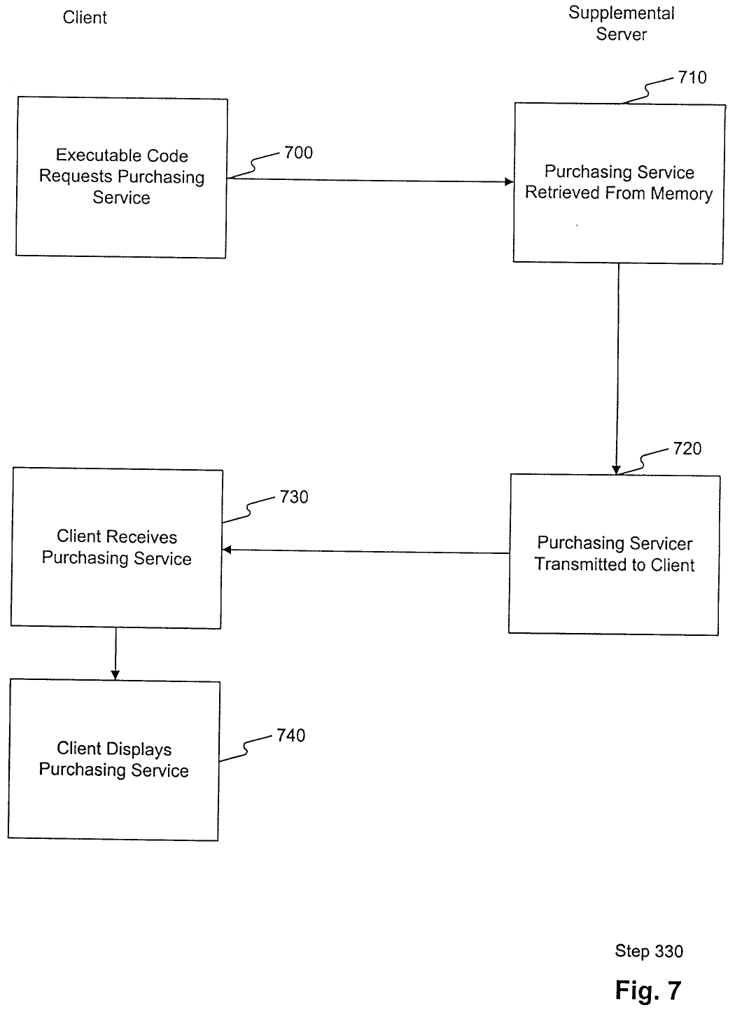

FIG. 3 is a flowchart of an overview of a possible implementation of the present invention. The process begins with a web browser 252 requesting data (step 300). The web browser 252 receives the requested data (step 305) (see FIG. 4). The data includes content 264, variable data 272, and executable code 279. A determination is made whether the variable data 272 requires updating (step 310). This step may be performed in a variety of ways, which will be discussed below in connection with FIG. 6. If no update is required, then the variable data 272 presents the user operating a client with a product offering that has real-time values associated with it (step 320). If the variable data 272 requires updating, the variable data 272 will be updated (step 315), and then the user operating a client will be presented with a product offering that has real-time values associated with it (step 320). The user will have the option whether to select the product offering (step 325). If the user does not select the product offering, the cycle will return to the inquiry of whether the data requires updating (step 310). If the user selects the product offering, a purchasing service 278 will be invoked (step 330) (see FIG. 7). The user will have the option to purchase the product offering (step 335). If the user does not select to purchase (step 340), the method will cycle to inquiry of whether the browser requires updating. If the user selects to purchase the product offering, the sale will be completed (step 345).

One skilled in the art will recognize that this cycle could terminate at any point by a variety of means, including but not limited to the user visiting a different site, disconnecting from the network, disengaging the web browser, or other means known.

One skilled in the art will further recognize that the selection of the product offering and invocation of the purchasing service 278 may be compressed into one step. Accordingly, selecting the product offering would result in completion of the sale thus obviating steps 335 and 340.

FIG. 4 expands step 305 of FIG. 3. Upon receiving a request for data from the browser, client 102 requests data from server 120 (step 440), the server 120 retrieves responsive data from memory 260 (step 400). The data recognizes that additional information is required to fulfill the request and notifies the server of this (step 405). The server 120 request additional data from supplemental server 220 (step 410). Supplemental server 220 retrieves the responsive information—e.g., variable data 272 and executable code 279—from memory 270 (step 415). Supplemental server 220 transmits the variable data 272 and executable code 279 to server 120 (step 420). Server 120 receives the variable data 272 and executable code 279 from the supplemental server 220 (step 425). Server 120 transmits the content 264, variable data 272, and executable code 279 to the client 102 (step 430). The client 102 then displays the content 264 and variable data via the web browser (step 435).

One skilled in the art will recognize that the supplemental server 220 may transmit the variable data 272 and executable code 279 directly to the client 102 in step 420. In this scenario, step 425 is eliminated, and the data transmitted by the server to the client in step 430 is only that content not retrieved from the supplemental server 220.

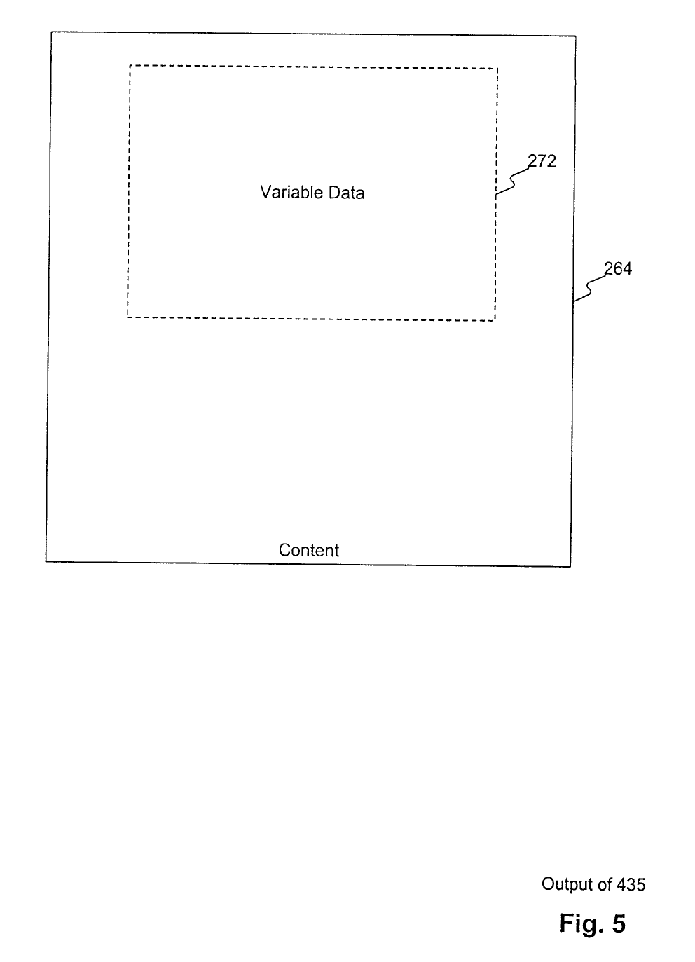

FIG. 5 illustrates the output display in step 435 of FIG. 4. The web browser temporarily displays the content 264 and the variable data 272 so long as a connection is maintained between the client 102 and the supplemental server 220.

FIG. 6 is a detailed flowchart of a possible implementation of step 310 from FIG. 3. The executable code 279 transmitted to the client 102 from the supplemental server 220 substantially continuously requests updates for the variable data from the supplemental server 220 (step 600) so that the variable data 272 displayed on the client reflects the most up-to-date information available. A request will occur at least every few minutes or so but will be necessarily limited by the capacity of the client device 102 and the speed of its connection to the network 100. The executable code 279 requests updates in a variety of ways including but not limited to requesting information every given fixed amount of time and on the occurrence of an event. The supplemental server 220 receives the request and, using the publish process discussed earlier, determines whether it has updated information to respond to the request (step 605). If the supplemental server 220 has no updated information, no change to the variable data 272 will occur. If the supplemental server 220 has received updated information, the supplemental server 220 will transmit the updated information to the client 102 (step 610), and the client 102 will receive the up-dated variable data 272 (step 615).

One skilled in the art will recognize that the executable code 279 could also request updated variable data 272 from the supplemental server 220 using the server 120 as an intermediary.

One skilled in the art will also recognize that this step could be accomplished by maintaining an open connection between the client 102 and supplemental server 220, such that the supplemental server 220 may transmit updated information, or publish information, as it is received without requiring a request from the client system 102.

FIG. 7 is a detailed flowchart of step 330 from FIG. 3. The executable code 279 invokes a purchasing service from the supplemental server 200 by requesting that such a service be retrieved from memory (step 700). The supplemental server 220 retrieves the purchasing service 278 from memory 270 (step 710). The supplemental server 220 transmits the purchasing service 278 to the client 102 (step 720). The client 102 receives the purchasing service 278 (step 730). The client 102 displays the purchasing service 278 via a web browser 252 (step 740).

The claims:

1. In a network comprised of a client device and at least two server devices, a method for providing real-time price information upon request, the method comprising:
receiving, at a first server device from the client device, a request for content;
providing, by the first server to the client device, the requested content; and
substantially continuously providing the client device updates to variable data referenced in the content, wherein the variable data is subject to update by the second server.

2. The method of claim 1, wherein substantially continuously providing the client device updates to variable data referenced in the content, comprises:
determining by at least one of the client devices and the first server device whether the content refers to variable data that is subject to modification by the second server.

3. The method of claim 1, wherein the providing step comprises:
transmitting executable code from the first server to the client device, wherein the executable code executing on the client device periodically establishes a communication link with the second server to receive any updates to variable data referenced in the content.

4. The method of claim 1, wherein the providing step comprises:
transmitting executable code from the first server to the client device, wherein the executable code executing on the client device generates the updates to the variable data based on detected conditions associated with the client device.

5. The method of claim 1, wherein the method further comprises:
providing, by the second server, an interface with a purchasing service.

6. The method of claim 1, wherein the providing step comprises:
providing variable data that has been narrowcasted.

7. In a network comprised of a client device and at least two server devices, a method for providing real-time price information upon request, the method comprising:
receiving, at a first server device from the client device, a request for content;
providing, by the first server to the client device, the requested content, and by the second server, variable data referenced in the content; and
substantially continuously providing the client device any updates to variable data referenced in the content, wherein the variable data is subject to update by the second server.

8. The method of claim 7, wherein the providing step comprises:
transmitting executable code from the second server to the client device, wherein the executable code executing on the client device periodically establishes a communication link with the second server to receive any updates to variable data referenced in the content.

9. The method of claim 7 wherein the providing step comprises:
providing, by the second server, an interface with a purchasing service.

10. The method of claim 7 wherein the providing step comprises:
providing variable data that has been narrowcasted.

11. A computer-readable medium containing instructions for controlling a data processing system to perform a method for providing real-time price information, said method comprising the steps of:
receiving, at a first server device from the client device, a request for content;
providing, by the first server to the client device, the requested content; and
substantially continuously providing the client device updates to variable data referenced in the content, wherein the variable data is subject to update by the second server.

12. A computer-readable medium containing instructions for controlling a data processing system to perform a method for providing real-time price information, said method comprising the steps of:
receiving, at a first server device from the client device, a request for content;
providing, by the first server to the client device, the requested content, and by the second server, variable data referenced in the content; and
substantially continuously providing the client device any updates to variable data referenced in the content, wherein the variable data is subject to update by the second server.

13. A data processing system for displaying real-time product information, comprising:
a memory having program instructions; and
a processor responsive to the program instructions to: receive a request for variable data and executable code, respond to the request for variable data and executable code, receive substantially continuous requests for updates to the variable code, and to respond to the substantially continuous requests for updates to the variable code.

14. A data processing system for displaying real-time product information, comprising:
a memory having program instructions; and
a processor responsive to the program instructions to: receive substantially continuous requests for variable data and provide substantially continuous updates to the variable code.
